(19) United States
(12) Patent Application Publication
(10) Pub. No.: US 2022/0178480 A1
(43) Pub. Date: Jun. 9, 2022

(54) RELEASING DEVICE FOR DISCONNECTING A PIPE OFF OF A FITTING BODY

(71) Applicants: Jacob FRIEDRICH, TIVON (IL); Avraham TAVOR, YOKNEAM ILIT (IL)

(72) Inventors: Jacob FRIEDRICH, TIVON (IL); Avraham TAVOR, YOKNEAM ILIT (IL)

(21) Appl. No.: 17/112,999

(22) Filed: Dec. 5, 2020

(51) Int. Cl. F16L 37/092; F16L 37/248; F16L 37/23

(52) U.S. Cl. CPC F16L 37/0927; F16L 37/23; F16L 37/248

(57) ABSTRACT

The invention is a device for releasing and disconnecting a fitting body off of a pipe, which is held with a gripping ring that holds the pipe in fixed position inside the fitting body. Particularly, the device is integrated into valves for disconnecting domestic valves installed over pipes, which are fixed to and extending out of walls. The essential parts of the device are a nut, a pushing sleeve matching into the nut and one or more spiral tracks that couple with bump(s)/ball(s) on the surfaces of the nut and sleeve. This coupling enables radial movement of the nut in a defined spiral forward direction over the fitting body and pushes the sleeve into the fitting body for releasing the pipe off of the gripping ring.

### TECHNICAL FIELD

The present invention pertains to disconnecting of fittings for connecting water pipes. For example, the present invention pertains to a device integrated into valves for disconnecting domestic valves installed over pipes, which are fixed to and extending out of walls.

### BACKGROUND

Valves and other fittings for installation in households are designed with a bore to couple with a pipe or tube that extends out of a wall and connects them to either another pipe, to the local water piping system or to an end-product as a toilet or dishwasher. The water flow is confined to the volume of the pipe and valve until reaching the valve exit. In certain practices, the pipe is smooth and simply introduced into the bore within the valve or fitting. This, however, requires that the valve firmly holds the pipe within it to prevent movement of the pipe and water leakage due to the internal pressure of water in the pipe.

A commonly used solution for fixing the pipe within the inner space of the valve and preventing leakage is a gripper ring. The gripper ring is essentially a ring with sharp teeth that extend longitudinally in inclined inward position relative to the ring. The pipe passes through the gripper ring until stopped by a step inside the fitting body, and the gripper ring teeth that hold to it without letting it retract or move from its place. O-rings are located inside a cavity in the fitting body and intended to seal the gap between the pipe and the body to prevent water leakage. But the gripper ring creates a problem when disconnecting the valve or fitting from the pipe, since its contact with the pipe is based on a relatively strong friction force in the longitudinal direction of the pipe. Therefore, a disconnection of the valve/fitting off of the pipe requires application of a significant force to push the gripper ring teeth even more, to overcome the friction force, thus allowing the pipe to be extracted.

Various solutions are provided to reduce the required force required to extract the pipe. Many of these solutions are provided by Accor Technology Inc. and described in the following patents and patent applications: U.S. Pat. Nos. 6,464,266, 6,880,523, 7,232,159, 7,523,966, 7,810,850, US 2015/0076816 and U.S. Pat. No. 8,820,799. For example, U.S. Pat. No. 8,820,799 describes a valve with more than one gripper ring and a spacer bushing with circumferentially spaced axial grooves in its inner side. The gripper ring teeth fit to the grooves of the bushing and are twisted against the walls of the grooves so that when a radial movement is done to disconnect the valve from the pipe, the teeth press against the walls of the grooves and so are lifted and detach from the pipe. This enables to release the valve off of the pipe by application of a screw-like action between the pipe and the valve, thus screwing the pipe out of the gripper ring teeth. This method has a disadvantage of creating external damage to the pipe by the gripper ring teeth, not enabling to re-install the pipe into another valve or fitting without repairing the pipe surface or cutting the damaged part of the pipe. In other prior arts, a pressure-ring is introduced in the fitting, which is intended to be pressed manually by the user by applying axial force on a sleeve in order to release the pipe. This solution required high pressure forces, and generally requires special tools to perform this pressing action due to the high required force. It is, therefore, an object of the present invention to provide an improved solution for releasing a valve or fitting off of a pipe in domestic or other applications, where such valve or fitting uses a gripper ring for holding to a water pipe extension.

It is yet another object of the present invention to provide a valve or fitting with gripper ring and an integral or modular component for releasing the gripper ring hold of the valve/fitting to an extension of a water pipe inserted in it.

### SUMMARY

The present invention pertains to a releasing device for disconnecting a fitting body off of a pipe that comprises:

one or more spiral tracks;

at least one bump/ball;

a nut; and

a pushing sleeve with a conical tapered shape,

wherein coupling of the bump(s)/ball(s) with the spiral track(s) enables radial movement of the nut in a defined spiral forward direction over the fitting body and pushing of the pushing sleeve into the fitting body for releasing a pipe held inside off of a gripper ring that holds the pipe in fixed position inside the fitting body.

In one particular embodiment, the diameter of the nut is larger than the diameter of the fitting body and the nut overlaps the fitting body. In another particular embodiment, the bump(s)/ball(s) are located on the inner wall of the nut and the spiral track(s) are located on the outer wall of the fitting body. In still another embodiment, the bump(s)/ball(s) are located on the outer wall of fitting body and the spiral track(s) are located on the inner wall of the nut.

In one embodiment, diameter of the fitting body is larger than the diameter of the nut. In still another embodiment, the bump(s)/ball(s) are located on the outer wall of the nut and the spiral track(s) are located on the inner wall of the fitting body. In still another embodiment, the bump(s)/ball(s) are located on the inner wall of the fitting body and the spiral track(s) are located on the outer wall of the nut.

In one particular embodiment, the fitting body is a valve. Further, the bump(s) may be of any suitable shape that enables their smooth movement inside the spiral track(s). Particularly, the bump(s) may be rectangular or round.

In one embodiment, the nut and pushing sleeve form an integrated releasing device. In another particular embodiment, the nut and pushing sleeve form a modular releasing device.

In one aspect, the present invention provides an assembly for disconnecting a fitting body water piping off of a pipe, where the assembly comprises:

a releasing device as described and illustrated in the present application;

a fitting body;

at least one bump(s)/ball(s) located on a nut of the releasing device or the fitting body;

at least one spiral track(s) located on the fitting body or on the nut in correspondence with the location of the bump(s)/ball(s), where the bump(s)/ball(s) are configured to couple with each other to enable spiral downward movement of the releasing device over or in the fitting body;

a conical ring for holding a gripper ring in fixed position;

a gripper ring for locking the pipe in fixed position within the fitting body, the gripper ring comprising teeth extending radially in inclined angle towards the center of the gripper ring and frictionally holding the pipe in its fixed position;

a locking ring for accommodating the pushing sleeve, locking all parts of the assembly in fixed position; and

a sealing ring for sealing a gap between the receiving end of the pipe and the conical ring

### BRIEF DESCRIPTION OF THE DRAWINGS

FIG. 1 illustrates a cross-section of the housing of a valve with a nut in screwed position.

FIG. 2 illustrates another cross-section of valve housing with the nut in initial position.

FIG. 3 illustrates a perspective, isometric, view of the valve housing and outlets and connection means to the nut.

FIG. 4 illustrates an exploded view of all of the parts of the valve pushing sleeve and nut in the modular configuration.

FIG. 5 illustrates another exploded view of the valve parts with the pushing sleeve integrated into the nut.

FIG. 6 illustrates a partially exploded view showing the valve housing with means to connect with the nut and the pushing sleeve.

FIG. 7 illustrates another partially exploded view of the valve and nut with the pushing sleeve housed or integrated in the nut.

FIG. 8 illustrates frontal exploded view of the valve parts, nut and pushing sleeve for disconnecting the valve off of the water pipe.

FIG. 9 illustrates another frontal exploded view of the valve parts and with the pushing sleeve housed inside nut.

FIG. 10 illustrates a perspective bottom view of the nut and pushing sleeve.

FIG. 11 illustrates a perspective of view of the valve housing and the nut exposed inner wall.

FIG. 12 illustrates a cross-section view of the valve housing, piston and gripper ring and nut and pushing sleeve before screwing action.

FIG. 13 illustrates another cross-section view of the valve housing, piston and gripper ring and nut and pushing sleeve in screwed position.

FIGS. 14-16 illustrate a particular embodiment of the gripper ring releasing device with additional reinforcement of the fitting body.

### DETAILED DESCRIPTION OF THE DRAWINGS

The main disadvantage of current solutions for disconnecting a valve from a water pipe is the application of significant force that a user should apply to detach the gripper teeth off of the pipe surface. Such force is oriented longitudinally relative to the pipe main axis, but has to move the teeth essentially radially relative to this axis. The releasing device of the present invention overcomes this difficulty by providing a screw mechanism that reduces the force that a user has to apply on the one hand, and increases the applied stress on the gripper ring on the other hand.

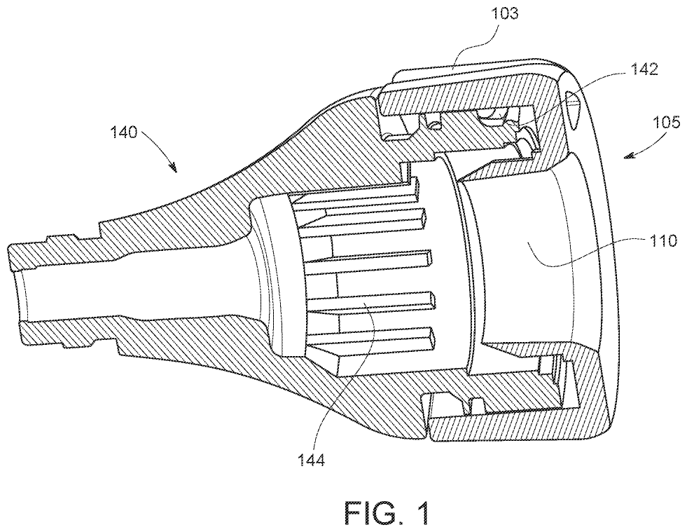

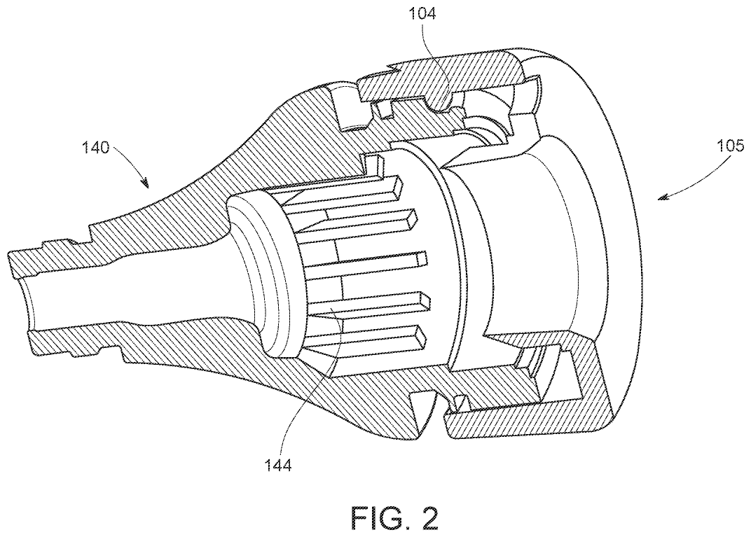

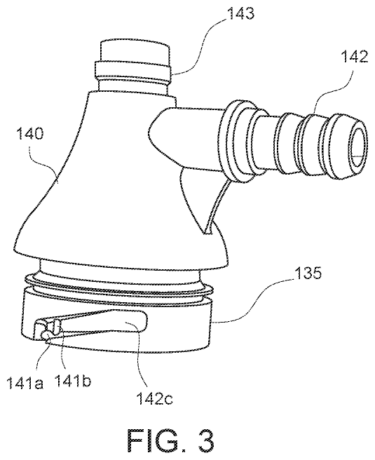

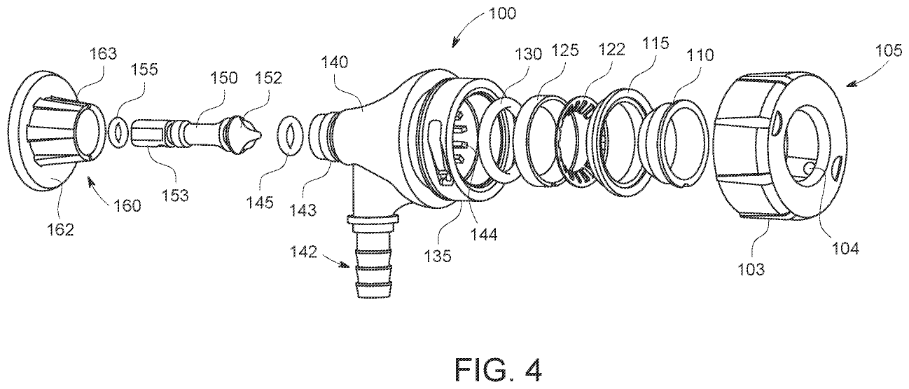

The cross-section views in FIGS. 1 and 2 show the device of the present invention in two positions: FIG. 2 shows the device before application, and FIG. 1 shows the device after rotating the nut and pressing the gripper ring teeth. FIG. 4 illustrates an exploded view of the valve and device 100 for releasing the gripper ring 122 off of a pipe (the pipe is not shown), which is inserted into the bore, which is the hollow space formed within the housing 140 of the valve 100. The main principle of the releasing device is the spiral movement of the nut 103 relative to the valve body 140. This movement creates axial movement of the pushing sleeve 110, which in turn applies pressure on the gripper ring teeth 122. The gripper ring teeth then perform axial movement relative to the pipe surface, and thus release their grip off of the pipe. In an alternative configuration, the pushing sleeve is integrated into the nut, and makes a combined axial and spiral movement in the direction of the movement of the nut. Such spiral turn of the nut and/or pushing sleeve has a two-fold advantage of alleviating the force, which is required to detach the gripper ring teeth off of the pipe, and increasing the force applied on the gripper ring sufficiently to vertically distance the gripper ring teeth from the pipe. The releasing device 105 itself essentially comprises a nut 103, a bump or ball 104 located on the inner wall of the nut and a pushing sleeve 110 with dimensions suitable to fit inside the inner space of the nut. The bump/ball 104 is placed on a specific location on the inner wall of the nut 103 and its size, i.e. radius, is fit to be inserted into a recess at the proximal end of track 142c, as shown in FIG. 3, at the outer surface of the side of the receiving end 135 of the valve housing. In one particular embodiment, tongues 141a and 141b keep the ball/bump in place until radial force is applied on the nut, which forces the ball/bump over tongue 141b and releases it to slide within the track. The track is inclined over the surface of the receiving end of the valve downwards at a selected angle, where its proximal end is closer to its upper edge and its distal end is closer to its lower end. When the nut is turned, the ball/bump is moving inside the track and guides the nut in radial movement down. Pushing sleeve 110 lies over spiral conical ring 115 and in contactless position relative to the nut, so that when the nut is turned, the pushing sleeve is axially forced down in the space of the gripper ring. Alternatively, the pushing sleeve is integrated into the nut and held within the nut to enable simultaneous radial and axial movement into the gripper ring. In the integrated configuration, when the nut is turned, making a radial movement downwards with the guidance of the ball/bump down the track, the pushing sleeve makes a corresponding downward radial movement and is pushed down into the space enclosed by spiral conical ring, which is a locking ring 115, into the space of gripper ring 120.

Locking Ring 115 is held-on very firmly to the valve body 140 by mechanical means or by welding or by glue. The conical ring prevents the gripper ring from extracting out of the valve body during the dismantling process or during removal of the valve from the pipe. The conical ring prevents excessive axial movement of the gripper ring, but allows free rotation of the gripper ring to allow the pipe to be freely rotated after installation.

Conical ring 125 is sloped with an inner slope that is steeper relative to the slope of the teeth 122 of the gripper ring. This difference in slopes allows the teeth to bend outwards when pressed through the conical ring 125 as a result of the pressure that the pushing sleeve applies on them.

The pushing sleeve 110 has a conical shape with circumference at its lower edge that fits the diameter of the gripper ring. As it is pushed down by the force applied by the nut, its gradually increasing diameter towards its upper edge pushes the teeth 122 of the gripper ring 120 outwards relative to the surface of a pipe, which is held in the valve. This displacement of the teeth results from the downward axial or combined axial and radial movements of the pushing sleeve and its conical shape that forces them away from the pipe. As the pipe is released from gripper ring teeth, the valve is released and can be pulled away from the pipe.

The particular application of the screw threading principle to push the gripper ring of a valve, which is installed on pipes of a domestic water piping systems, requires accurate dimensions of all the participating components and exact matching between the different parts of the releasing device and the parts of the valve. The location of the bump/ball on the inner wall of the nut of the releasing device is also important, in addition to the required accuracy of match between the dimensions of the bump/ball and the spiral track on the receiving end of the valve housing. This location is essential to ensure that the bump/ball is actually introduced into the spiral track within a defined turn of the nut over the receiving head of the valve or any other fitting body. For example, a quarter of 360 degrees turn of the nut is usually needed to effect sufficient stress on the gripper ring and consequently its teeth for separating them from the pipe's surface. Thus, a design of location and dimensions of the bump/ball in the nut that matches the design and dimensions of the valve or fitting body receiving end and the gripper ring, locking ring between it and the nut and conical ring 125 between it and seal or O-ring 130. The conical ring itself provides a base for accommodating and fixing the gripper ring in place.

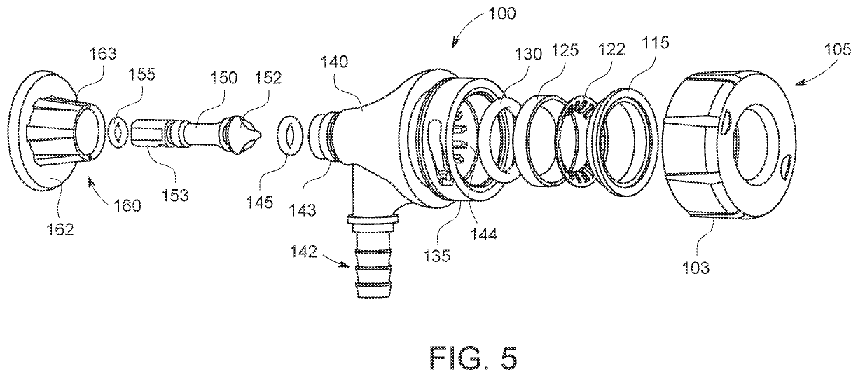

As mentioned above, the ball/bump may make a quarter of a turn in the spiral track for disengaging the gripper ring teeth off of the water pipe. The user is required to apply only minimal work to turn the nut and make the ball/bump travel down the spiral track at the receiving end of the fitting body and push the nut into the inner space of the gripper ring. The force that the nut applies relays the stress to the gripper ring teeth by direct contact with the pushing sleeve conical surface, as the pushing sleeve travels down axially or in combined axial and radial movement depending on the configuration of the nut and pushing sleeve. The increasing diameter of the pushing sleeve from its proximal end to distal end generates friction between the sleeve and the teeth and forces them apart from the pipe surface. The particular assembly of the nut, ball/bump and pushing sleeve requires that the sleeve 110 be located within the nut with a gap between its outer surface and the inner surface of the nut. In one particular embodiment, the nut and the pushing sleeve are two separate parts as shown in FIG. 4. In yet another embodiment, the nut and the pushing sleeve form an integral part. Namely, the pushing sleeve may form a single solid part with the nut, for example be moulded with the nut in one cast as shown in FIG. 5. A two balls/bumps configuration also requires two corresponding spiral tracks at the receiving end of the valve or fitting body. Namely, to revolve the nut over and down the receiving end, two opposing balls/bumps are inserted into two corresponding opposing spiral tracks at the outer surface of the receiving end of the fitting body.

The valve or fitting body and releasing device, namely nut and pushing sleeve, further comprise other components, which may be common, standard or customized, but should all be configured to maintain the functionality of the releasing device and structural and functional match between this device, the spiral track(s) of the valve/fitting body housing and gripper ring. Particularly, the valve comprises a handle 160 with a flat disc 162 and trimmed conical hollow knob 163. The handle accommodates a piston 150 with a base 153 that fits the space of the hollow knob. The piston has an upper pointed head 152 that introduces into the valve housing 140 and reaches beyond the upper opening of nozzle 142. When the handle is pulled backwards from the housing, the piston is retracted from the housing and blocks the water path from the housing to the nozzle. When pushed into the housing, the piston unblocks the water path from the housing to the nozzle outlet. O-rings 155 and 145 are made from elastic material for sealing the gaps between the piston and housing from leakage of water.

In the particular example illustrated in the drawings, the housing 140 is in the shape of a cone having the wider aperture at the interface with the releasing device and narrows towards the nozzle outlet. The part 144 closer to the wider aperture is ribbed. Above the ribbed part there is the receiving end 135 of the housing with the spiral track(s) 142c which is carved at its outer wall. FIGS. 1 and 2 show the two positions of the releasing device during, FIG. 2, and at the end of, FIG. 1, the releasing action (the gripper ring is not shown in these Figures). In FIG. 2 the nut is shown in an elevated position relative to the receiving end of the valve housing with the ball/bump entering the spiral track. FIG. 1 shows the nut at the end of its turn, reaching the top surface of the receiving end of the valve housing. This shows that the design of the releasing device should accurately match the design of the valve or any other fitting body, including the dimensions and relative locations of their parts that communicate with each other.

O-ring 130 water-seals the engagement area between the receiving end of the housing and the conical ring 125 and the pipe. Locking ring 115 fits on top of the gripper ring 120 and is mechanically secured to the housing by means of welding or screwing or any other method. Locking ring 115 is used to hold the assembly of rings including the gripper ring in fixed axial position. The gripper ring, however, is free to rotate together with rotation of a pipe, which is inserted and held inside the valve.

FIG. 3 illustrates the shape of specific valve housing in accordance with illustrations of the valve and matching releasing device. This valve, or any other fitting body, should be adapted to the releasing device of the present invention with at least one spiral track at the outer wall of the receiving end of the fitting body/valve. This spiral track fits the dimensions of the ball/bump in the nut. In one embodiment, the spiral track is located on the outer wall of the housing and the corresponding ball/bump is located on the inner wall of the nut. In yet another embodiment (not shown), the spiral track is located on the inner wall of the housing, and the ball/bump located on the outer wall of the nut. The main principle is maintained of using bumps/balls and spiral tracks as coupling means for communicating a force through the nut to the fitting body for releasing the gripper ring teeth off of the pipe.

FIG. 4 illustrates the valve/fitting body and releasing device in exploded view with all their parts including the pushing sleeve 110. This figure actually displays the modular embodiment of the present invention, where the pushing sleeve is independent from the nut as detailed above.

FIG. 5 illustrates the valve and releasing device in exploded view with the pushing sleeve integrated into the nut of the releasing device. This figure illustrates the second integrated option of the device with the pushing sleeve moulded together with the nut in one solid piece.

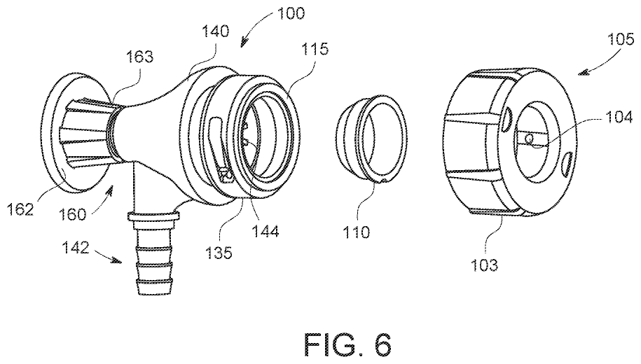

FIG. 6 focuses on the three components, nut and pushing sleeve of the releasing device and valve or fitting body in exploded view. This figure illustrates the modular configuration of the releasing device, namely the pushing sleeve is independent from the nut, which allows for its axial movement when pressed by the nut without simultaneous radial movement.

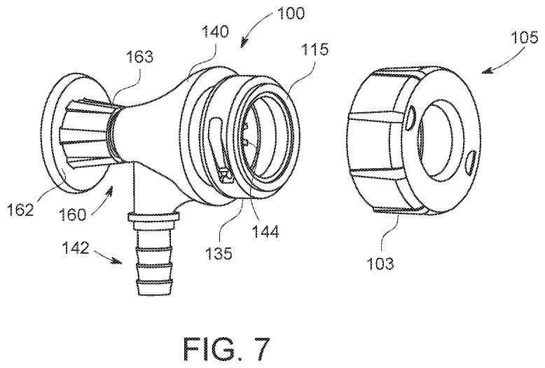

FIG. 7 illustrates the pushing sleeve integrated into the nut and moulded as one piece with it. In such releasing device, the nut, balls/bumps and pushing sleeve form a continuous solid part. Particularly the sleeve is moulded together with the balls/bumps, thus it remains firmly fixed in a place centred inside the nut and leaving a gap relative to the nut inner walls. In this integrated configuration, the nut makes simultaneous axial and radial movements, i.e. spiral movement, according to the turning of the nut.

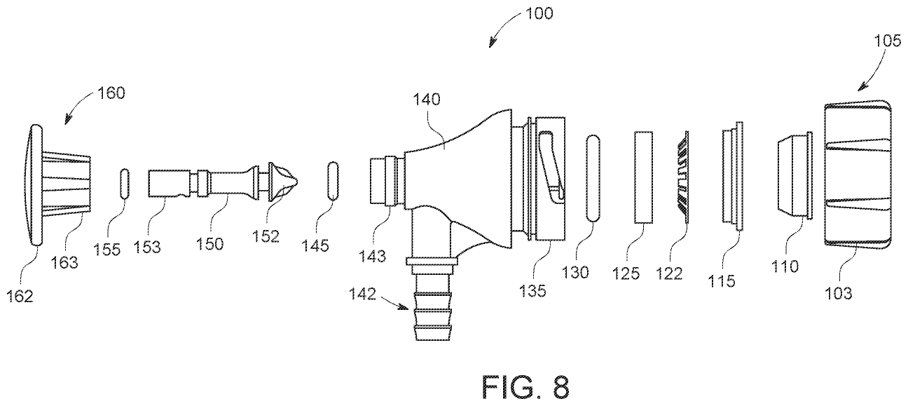

FIG. 8 illustrates a front exploded view of the valve or fitting body and releasing device with all parts as shown in FIG. 4. Namely, the releasing device is shown in its modular configuration, with the pushing sleeve being indepen8dent from the nut, and centred inside the nut when the balls/bumps turn inside the spiral tracks.

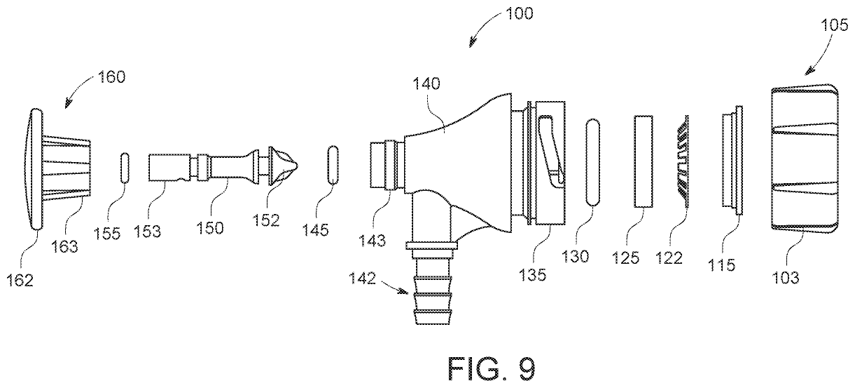

FIG. 9 illustrates a front exploded view of the valve or fitting body and releasing device with the pushing sleeve accommodated inside the nut in integral mode of the releasing device as shown in FIG. 5 and explained above.

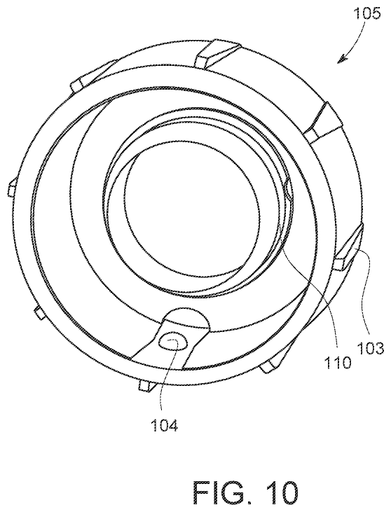

FIG. 10 is a perspective view illustrating the interior space of the nut of the releasing device with the bump/ball at its inner wall and the matching pushing sleeve.

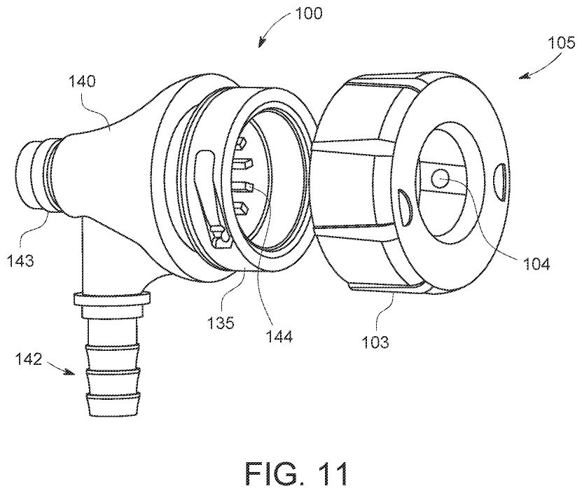

FIG. 11 illustrates an isometric view of the main parts of the valve/fitting body and releasing device not showing the pushing sleeve and exposing one of the bumps/balls 104 on the inner wall of the nut. The locking ring, conical ring, sealing rings and gripper ring are accommodated over the receiving part of the valve housing 100. Ribs at the outer surface of the nut 103 enable a better manual grip with a user hand. This Figure better illustrates the coupling of the nut and valve or any other fitting body, where such coupling is enabled by the insertion of the bumps/balls inside the spiral tracks on the outer surface of the receiving part of the valve/fitting body.

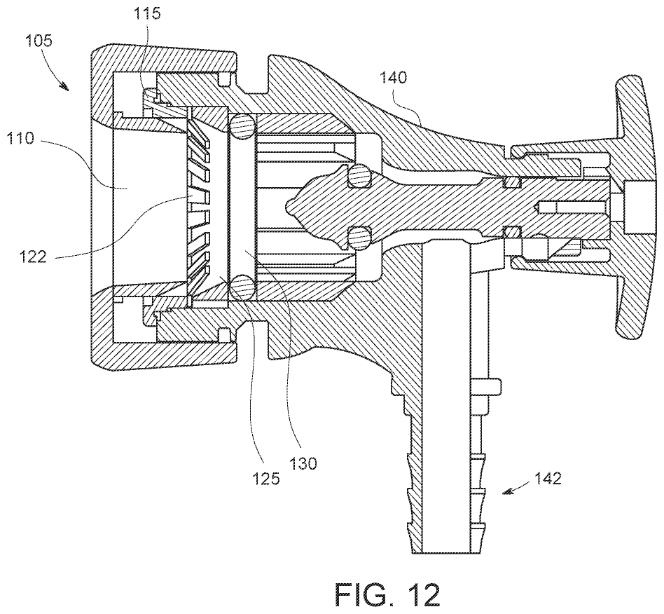

FIG. 12 is a cross-section of the valve housing, showing the location of the gripper ring under the receiving end of the housing with the gripper ring teeth 122 oriented towards the surface of a pipe (the pipe is not shown) that is inserted into the bore within the valve. It should be noted that the valve is only exemplary of any fitting body into which a pipe is inserted and fixed in place with a gripper ring. The nut 105 and pushing sleeve 110 are shown in their position in initial contact with the gripper ring before application of force on the gripper ring teeth 122. The teeth are still oriented inwards toward the pipe before the nut completes its spiral turn. Sealing ring 130 is also in a non-pressed position between the conical ring 125 and housing of the valve. Conical ring 115 still maintains a gap from the nut and allows the pushing sleeve 110 that it holds to stay in stable and relaxed position before rotating the nut and applying force on the pushing sleeve. The piston is shown in position that unblocks the communication between the housing and nozzle 142 and allows water to flow from the pipe out to the exit.

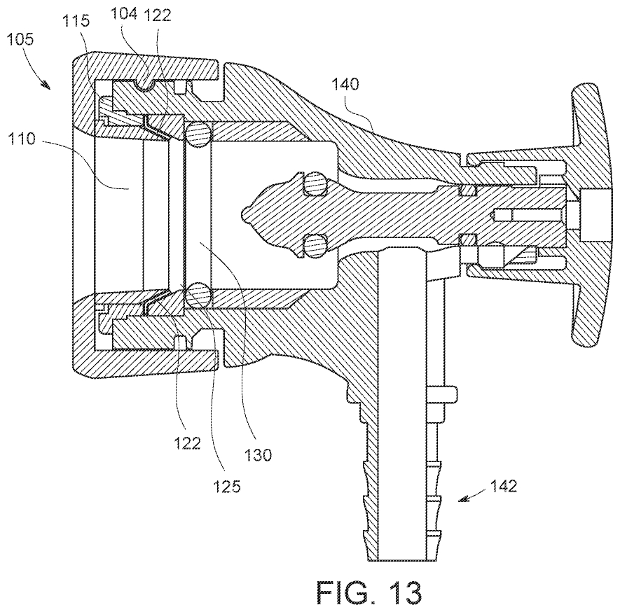

FIG. 13 is a cross-section of the valve housing and releasing device in compressed position, where the nut completes a spiral turn over the receiving end of the valve and turns the pushing sleeve down into the gripper ring. Accordingly, the bump/ball 104 completes its path inside the spiral track and reaches its end. Pushing sleeve 110 pushes the gripper ring teeth 122 outwards relative to the pipe, which is held in the valve. The teeth are initially inclined inwards and upon turning of the nut are pressed against the nut as shown in the Figure.

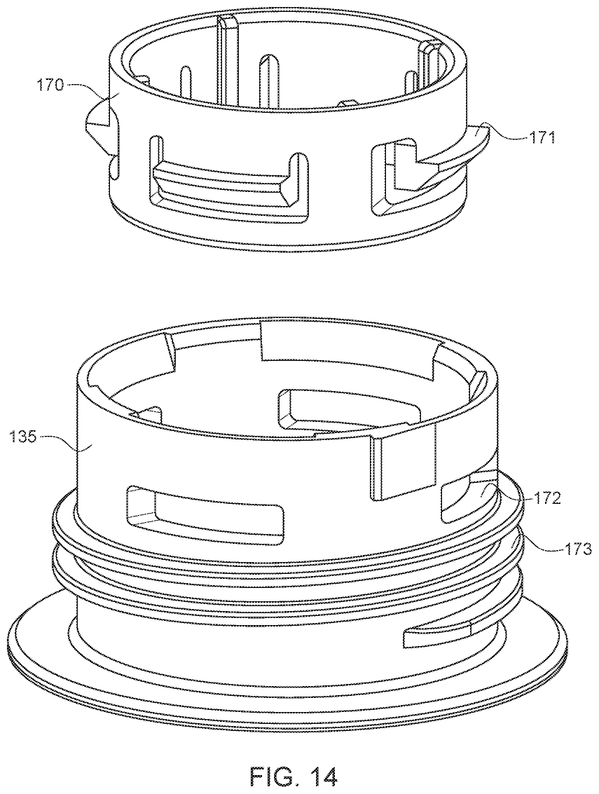

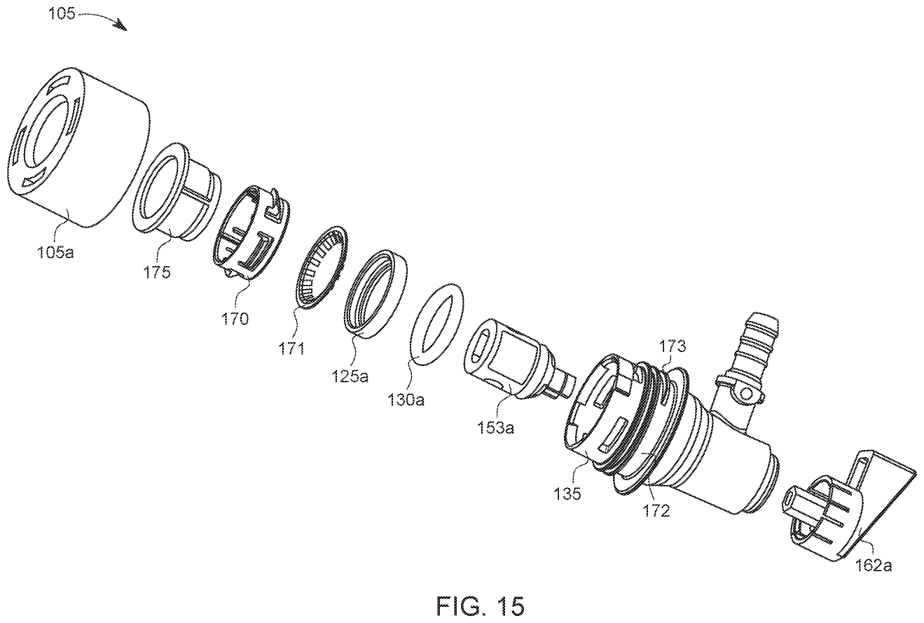

FIGS. 14-16 illustrate a particular embodiment of the releasing device 105 with additional reinforcement for the receiving end of the fitting body (e.g., valve) 135 for ensuring it is locked and fixed in place as the nut 105a turns it raidally to release the gripper ring 120 in order for the assembly of the releasing device and gripper ring to resist pressure of the water that flows through the pipe. In general, this reinforced version of the releasing device 105a comprises a locking ring 170, see FIG. 15 that comprises snaps 171, see FIG. 14, at its outer surface. These snaps 171 lock in corresponding slots 172, see FIG. 14, in the receiving end 135 of the fitting body, when all the parts of the releasing device are assembled together and connected to the fitting body. The locking of the snaps 171 within the slots 172 provides additional resistance to pressure of water that flows inside and through the pipe that is held in the fitting body. This coupling enables axial movement of the gripper ring while allowing its free rotation in order to allow the pipe to freely rotate after installation. These snap-slot couplings hold firmly the fitting body 140 (see FIGS. 9 and 13, for example) mechanically to ensure that the entire assembly holds in place and resists the pressure of water flowing inside and through the pipe.

In this particular example, the pushing sleeve 175 is parallel to pushing sleeve 110 in the previously presented example. The conical ring 125a hosts the gripper ring 120, and the sealing ring 135a seals the gap between the conical ring 125a and element 153a that presses against locking ring 170 and ensures that it is secured to the fitting body 135 with the snap-slot coupling.

In another embodiment, the corresponding snaps 171 and slots 172 switch locations between them, so that the slots are made in the surface of the locking ring 170 and the snaps protrude out of the outer surface of the receiving end 135. The locking is remained the same. In one example, the number of snaps and corresponding slots is four for each. The slots may go through from the inner to the outer surfaces of the wall of the receiving end or non-through to lock the snaps. Handle 162a turns to one direction to block water path from the pipe to the nozzle (see in FIG. 9, for example). When the handle 162a turns the opposite direction, it unblocks the water path from the water pipe to the nozzle outlet.

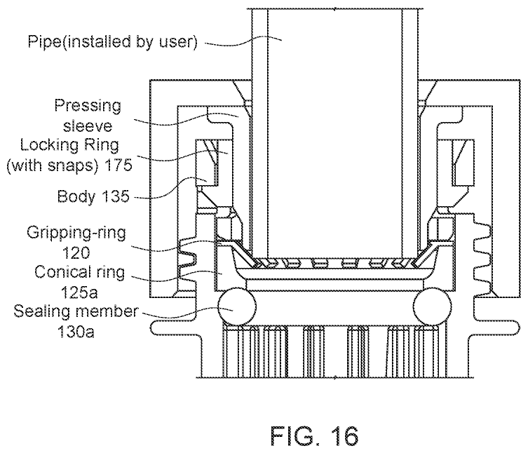

FIG. 15 illustrates the a close view of the locking ring 170 and receiving end of the fitting body 135 with the particular configuration of the snaps 171 extending out of the surface of the locking ring and through slots 172 in the fitting body. Spiral track 173 extends out on the outer surface of the receiving end of the fitting body. FIG. 16 is a cross-section of the releasing device in its assembled state, showing the pipe inserted into the fitting body and held by the gripper ring. The locking ring is coupled with the receiving end of the fitting body and holds the assembly of the releasing device against pressure of water that flows inside and through the pipe. The pushing sleeve and sealing member are as in the previous example as illustrated and described.

Fixing the gripper ring in place and preventing axial movement is essential for proper operation of the releasing device. The two types of locking rings discussed above apply mechanical means to ensure this, but other means are also encompassed within the scope of the releasing device in the present application. Such means may apply welding of the receiving end or gluing it to the valve. In one example, the receiving end is welded to the valve in an ultrasonic process.

1. A releasing device for disconnecting a fitting body off of a pipe, said releasing device comprising:
one or more spiral tracks;
at least one bump/ball;
a nut; and
a pushing sleeve with a conical tapered shape,
wherein coupling of the bump(s)/ball(s) with the spiral track(s) enables radial movement of the nut in a defined spiral forward direction over the fitting body and pushing of the pushing sleeve into the fitting body for releasing a pipe held inside off of a gripper ring that holds the pipe in fixed position inside the fitting body.

2. The releasing device according to claim 1, wherein the diameter of the nut is larger than the diameter of the fitting body and the nut overlaps the fitting body.

3. The releasing device according to claim 2, wherein the bump(s)/ball(s) are located on the inner wall of the nut and the spiral track(s) are located on the outer wall of the fitting body.

4. The releasing device according to claim 2, wherein the bump(s)/ball(s) are located on the outer wall of fitting body and the spiral track(s) are located on the inner wall of the nut.

5. The releasing device according to claim 1, wherein the diameter of the fitting body is larger than the diameter of the nut.

6. The releasing device according to claim 5, wherein the bump(s)/ball(s) are located on the outer wall of the nut and the spiral track(s) are located on the inner wall of the fitting body.

7. The releasing device according to claim 2, wherein the bump(s)/ball(s) are located on the inner wall of the fitting body and the spiral track(s) are located on the outer wall of the nut.

8. The releasing device according to claim 1, wherein the fitting body is a valve.

9. The releasing device according to claim 1, wherein the nut and pushing sleeve form an integrated releasing device.

10. The releasing device according to claim 1, wherein the nut and pushing sleeve form a modular releasing device.

11. The releasing device according to claim 1, wherein said pushing sleeve is configured to move in axial or radial movement and push said gripper ring teeth radially relative to said fitting body.

12. The releasing device according to claim 1, further comprising a locking ring, said locking ring lies between said pushing sleeve and gripper ring, wherein said locking ring prevents said gripper ring from extracting out of said fitting body to resist pressure of water that flows through said pipe.

13. The releasing device according to claim 12, wherein said locking ring comprises snaps extending out of its outer surface and slots corresponding to said snaps, said slots are located at surface of a receiving end of said fitting body, said snaps and slots couple together to lock said locking ring to said receiving end and mechanically fix said gripper ring in position and resist pressure of water that flows through said pipe.

14. The releasing device according to claim 13, wherein said slots are through slots.

15. The releasing device according to claim 13, wherein said slots are non-through slots.

16. The releasing device according to claim 13, wherein said snaps extend out of inner surface of said receiving end of said fitting body and said slots are located on outer surface of said locking ring.

17. The releasing device according to claim 12, wherein said locking ring is welded to said fitting body.

18. The releasing device according to claim 17, wherein welding of said locking ring to said fitting body is done with ultrasonic means.

19. The releasing device according to claim 12, wherein said locking ring is glued to said fitting body.

20. The releasing device according to claim 12, wherein said fitting body is a valve.

21. An assembly for disconnecting a fitting body water piping off of a pipe, said assembly comprising:
a releasing device for disconnecting a fitting body off of a pipe, said releasing device comprising:
one or more spiral tracks;
at least one bump/ball;
a nut; and
a pushing sleeve with a conical tapered shape,
a fitting body;
a conical ring for placing a gripper ring in fixed position;
a gripper ring for locking the pipe in fixed position within the fitting body, the gripper ring comprising teeth extending radially in inclined angle towards the center of the gripper ring and frictionally holding the pipe in its fixed position;
a sealing ring for a water-tight seal between the pipe and fitting body; and
a locking ring configured for holding the assembly of rings including the gripper ring in fixed axial position; and
a sealing ring for sealing a gap between the receiving end of the fitting body and the locking ring,
wherein the bump(s)/ball(s) are located on the nut and the spiral track(s) are located on the receiving end of the fitting body,
wherein the bump(s)/ball(s) and spiral tracks are configured to couple with each other to enable spiral forward movement of the releasing device over or in the fitting body,
wherein coupling of the bump(s)/ball(s) with the spiral track(s) enables radial movement of the nut in a defined spiral forward direction over the fitting body and pushing of the pushing sleeve into the fitting body for releasing a pipe held inside off of a gripper ring that holds the pipe in fixed position inside the fitting body.

22. An assembly for disconnecting a fitting body water piping off of a pipe, said assembly comprising:
a releasing device for disconnecting a fitting body off of a pipe, said releasing device comprising:
one or more spiral tracks;
at least one bump;
a nut; and
a pushing sleeve with a conical tapered shape,
a fitting body; a gripper ring for locking the pipe in fixed axial position within the fitting body, the gripper ring comprising teeth extending radially in inclined angle towards the center of the gripper ring and frictionally holding the pipe in its fixed position;
a sealing ring for a water-tight seal between the pipe and fitting body; and
a conical ring configured for accommodating the gripper ring while allowing the gripper ring to rotate freely and allowing the gripper ring teeth to bend radially,
wherein the bump(s)/ball(s) are located on the fitting body and the spiral track(s) are located on the nut,
wherein the bump(s)/ball(s) are configured to couple with each other to enable spiral forward movement of the releasing device over or in the fitting body,
wherein coupling of the bump(s)/ball(s) with the spiral track(s) enables radial movement of the nut in a defined spiral forward direction over the fitting body and pushing of the pushing sleeve into the fitting body for releasing a pipe held inside off of a gripper ring that holds the pipe in fixed position inside the fitting body.
